(19) United States
(12) Patent Application Publication
(10) Pub. No.: US 2011/0047090 A1
(43) Pub. Date: Feb. 24, 2011

(54) System and apparatus to increase efficiency in matching candidates to job offers while keeping candidate privacy

(76) Inventors: Shlomit Sarusi, Ramat - Gan (IL); Jacob Sarusi, Ramat - Gan (IL)

Correspondence Address: SHLOMIT SARUSI, 10 MAHANAIM STREET, RAMAT-GAN, 52273, IL

(21) Appl. No.: 12/859,988

(22) Filed: Aug. 20, 2010

Related U.S. Application Data
(60) Provisional application No. 61/235,401, filed on Aug. 20, 2009.

(51) Int. Cl. G06Q 10/00

(52) U.S. Cl. 705/321

(57) ABSTRACT

System and apparatus to send candidate resume to job offers published in any of the medias while keeping candidate privacy and increasing effectiveness in finding the best candidate for job offer. The system is based on the ability to compare candidate results from third parties matching systems and increased effectiveness in tracking candidates in recruitment process.

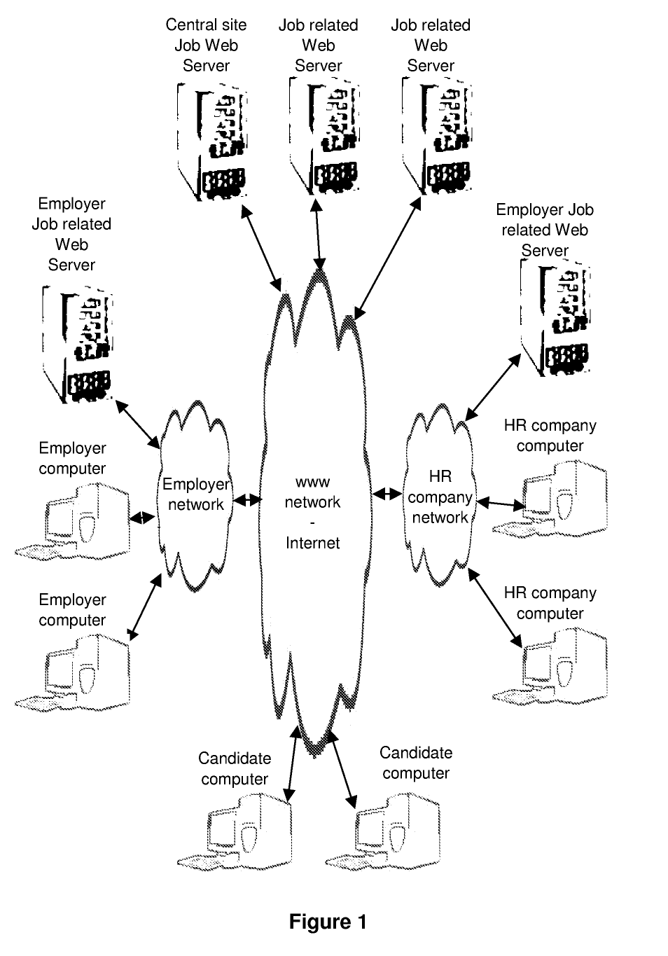

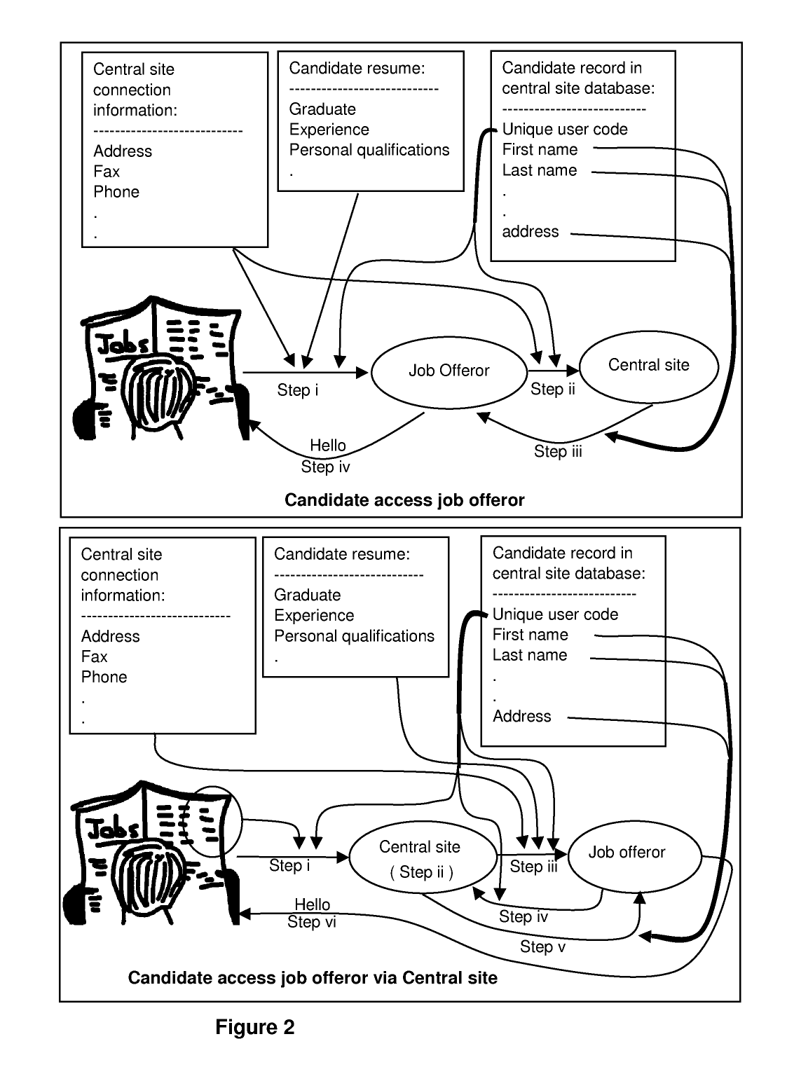

### FIELD OF THE INVENTION

The present invention relates to web based system and tools for matching candidates profile against job offers collected from all available medias and managing candidate and Job offerors to maximize handling efficiency while keeping candidate privacy. In particular, the present invention relates distributed database systems for matching Candidate/Offer related information over the Internet/Intranet and tools for managing and handling candidate recruitment filtering process.

### BACKGROUND OF THE INVENTION

The main source for job offers advertising is based on printed media (papers), head hunters (HR companies and agencies) and job related web sites.

Candidates (users) can apply for job offers or initiate job seeking by direct approaching potential Job offerors (jobs).

Common ways to seek job offers are to: (a) apply to printed media job opportunity, (b) register to one or more HR companies/agencies that matches job seeker profile with their available job offers and distribute matching job seeker details and profile to potential job offer, and (c) apply to web based job offer or register to one or more jobs related web sites that matches job seeker profile with job offers.

In many of these approaches, candidates private details are exposed without control, and without the ability to know the exposure rate. In the current situation, candidates need to decide whether to expose their private details or not apply. In order to increase job offer opportunities, job seekers sometimes register to all possible job seeking approaches and therefore on resume change need to update their profile in all HR agencies and job related web sites they are registered to.

Not only that candidate privacy is not possible, current job application does not support full advantage and effectiveness of the accelerating internet services in matching and filtering candidate to job opportunities from all available job offering medias.

Following are some of the problems raised from the current situation:
Job seekers problems:
   Discretion: Candidates using HR companies and agencies or using job related web sites to search for job opportunity cannot control the way their private information are handled. More than this, even when applying to printed media advertised job offer, candidates need to send their private information in order to allow Job offeror to contact them for further job recruitment procedures.
   Updates: Candidates that need to update their resume needs to repeat the update for all job related service provider.
   Inconsistency: due to different job related service provider approach, candidates may be ranked differently, and therefore may be ranked in a bad position relating to other candidates. In this case, the chances are that candidate profile will not be reviewed by the Job offeror.
   Tracking: Candidates need to track all job related service provider in order to find out for new job offers. Sometimes candidates miss job opportunity due to late application. Some job related web site offer automatic matching procedure to help prevent such job opportunity loss, but due to the inconsistency, it is not sure that the Job offeror will review their profile.
   Over exposure: Due to this multi registration and proactive initiated job seeking, Job offeror may encounter candidates resume and profile more then once for the same job offer, which generate psychological rejection. Since multiple companies may distribute candidate resume, each with different matching approach, it might happen that Job offeror encounters candidate resume for various different offers, which also generate psychological rejection.
      When candidate private details are also massively exposed to employers, it may cause long-term psychological rejection when encountering candidate name for new job offers.
      This kind of filtering can cause frustration and low self-esteem to candidates that are not invited for job interview.
Job offeror problems:
   Inconsistency: Job offeror encounter same problem as job seeker but from Job offeror point of view. Job offeror may encounter multiple profiles for the same candidate, which causes overhead in recruitment process.
   Tracking and management: while reviewing candidate profile, Job offeror may save candidate profile for future job offer.

Short time after issuing job offer, Job offeror may find that job seekers profile is not updated any more and candidates changed status to working. Thus, Job offeror need to re-issue job offer in order to get updated profiles. This may happen even though Job offeror is using a single HR company to find candidates. This happen since candidates are registered in many HR companies and many job related web sites, and candidates are approached from multiple source.
Uncertainty in finding the best candidate: Companies and job related web sites that uses automatic or semi automatic rating mechanism may use different priorities, thus resulting in different rating for a candidate for the same job offer. This may cause the lower rated candidate to be more qualified to a job offer than the top rated candidate. Since Job offeror usually read and examine the top rated candidates, they may not examine the best candidate for the job offer, even though the candidate was on the rated candidates list.
Multiple HR agencies/company limitation: Since Job offeror from convenience and expenses reasons, usually select a few source for HR companies or agencies. This may cause them to loss the best candidate since the candidate is registered to other HR company, or other HR company rated the candidate higher, or other HR company responded faster to the candidate profile or from other reasons.
Inconvenience: Usually, HR companies uses proactive methods to deliver candidates profiles to Job offeror, which means sending fax or email to the Job offeror as opposed to Job offeror seeking changes in a job offer status on the web or using job offer managing tool to track job offer and candidates status. This may cause inconveniency tracking candidates and job offers and may cause failure to select the best candidate from the candidates presented to the Job offeror.
Managing candidate screening from candidate resume database: After Job offeror HR people select candidates to process from the whole list of candidates, usually, selected candidates are transfer for professional assessment to relevant profession related people in the company which return the candidate to HR people, transfer the candidate for second opinion or use additional external sources for professional candidate examination. People involved in candidate recruitment are not aware at all times to the status and profession assessment of the candidate. Even when transferring the candidate recruitment data via emails, it is inconvenient to track for the related candidate last updated email. It is more critical when there is a need to compare various candidates assessment.

HR companies/agencies problems:
HR companies are facing the same problems as Job offerors. In addition, HR agencies cannot use job offers existing in other web sites or HR companies to matched their candidates.

Current situation problems are:
Candidates loss control on their private details.
It is common that Job offeror encounter same candidate profile more than once.
It is common that HR people must be involved in all stages of recruiting and choosing candidates.
Job offeror not always receive the best candidate in the market and candidates mostly are ranked according to the HR company criteria or job related web site criteria.

The Internet is a powerful tool and if used correctly can increase process effectiveness, including job seeking and job offering, while keeping candidates and/or employers privacy.

Therefore, what is needed is a method and system that answer current problem and supply efficient way to handle job offers and candidate profiles, by means of:
Handling job seeker privacy confidential and revealing private information in coordination with job seeker.
Handling all candidate profile in a way that will minimize candidate multi appearance to Job offeror.
Handling candidate profile in a way that candidate will apply its profile only once, and may have variation of their profile for different job profiles.
Allowing integration of new and existing filtering and sorting.
Allowing parametric Filtering and ranking mechanism to allow Job offeror, job related web sites and HR companies their preferred ranking method.
Allow Job offeror to manage job offers against candidate profile, progress and status.

### BRIEF SUMMARY OF THE INVENTION

Background of the Invention indicates some existing problems in job related processes. This invention defines system and method for increasing matching candidates to job offers efficiency, while keeping candidate and employers/HR companies privacy. This invention further defines tools to effectively control candidate recruitment process, including:
Centralized web based database for jobs, candidates and affiliate information.
Candidate enrolment system, generate user unique code per candidate
Affiliate enrolment system
Multi level Job/candidate matching system, including this invention matching system and 3ed party matching system.
Candidate resume distribution using user unique code, saving user private details confident.
Candidate job control system
Affiliates job/candidate control system, including job/candidate benchmark based on multi level matching system results.
And more

These system block allows all parties in job/candidate matching process to better perform by means of accurate and fast matching procedure that matches against central site database, affiliate database and 3ed party database.

### DEFINITION LIST

Following are term definition that will be used throughout the specifications:
“Central site”—Centralized database for job offers, candidate profile, company profile and HR agencies together with an interface that allows:
   Candidate registration and “User unique code” issuing to allow candidate to apply their profile in a discreet way.
   “Job offeror” to issue new job offer and manage it further on, select and work closely with its HR companies partners.
   HR companies to add candidates and/or job offers and work closely with its candidates and “Job offerors” and manage all its job offers.
   Candidates profile to be matched and rated against job offers, and compares matching results from third party to increase results accuracy and efficiency.
“Basic registration”—Registration of candidate private information that may include username/password, names, phones, address, electronic contact details like ICQ, Messenger, Skypee and the like. This “Basic registration” is finalized by issuing a “User unique code” to be used as the candidate contact information throughout all job seeking activity.
“Occupational profile”—candidate profile that includes all candidate jobs related profile such as education and degrees, courses, language, experience and the like. This job related profile is acquired using the “Central site” non-private contact forms.
“Full registration”—“Central site” registration after filling both “Basic registration” and “Occupational profile” forms.
“User unique code”—unique code composed of alphanumeric characters. This “User unique code” is used by the candidate throughout job seeking activity. Candidates required to send their profile to job offer found in the printed media and/or any other media that allow them to apply by sending resume, will instruct the “Central site” to send their profile to the Job offeror. Instead of user private contact details and name, candidate profile will include his “User unique code” together with the “central site” contact details like emails and phone that will expose candidate details per demand and candidate approval. Candidates required to fill up their private information to web sites that are not connected to the “Central site”, will fill in their “User unique code” together with the “Central site” contact details like emails and phone, that will expose candidate details per demand and candidate approval. Web sites that are connected to the “Central site” will allow issuing the “User unique code” for registered candidate or allow the candidate to link to registration process in the “Central site”. Same apply to HR companies. “User unique code” should be computer generated or any other code that is unique. In the preferred embodiment of this invention, this code should be a secure computer generated unique code.
“Record number”—Identifier for candidate with “User unique code” to allow convenient result comparison for results from various web site that matches candidate and job offer. “Record number” is unique for “User unique code”.
“Convenience buttons”—buttons presented in connected web site to allow candidates to access “Central site” by means of username/password for retrieving “User unique code” and/or “Basic registration” information and/or “Occupational profile” from the “Central site”. The information retrieved is applied directly to connected web site forms.
“Job offeror”—company or HR agency that issue job offer for their purposes or for companies represented by them.
“Candidate status”—status defined for candidate by the “Job offeror” while reviewing the candidate for the position. Status may include “interview scheduled”, “freeze”, “rejected”, “terms review”, “accepted” and the like.
“Candidate control page”—dedicated page related to a candidate per job offer, this page includes all activities related to the candidate while reviewing the candidate. It includes transfer table, recommendation, notes and “Candidate status”.

### BRIEF DESCRIPTION OF THE SEVERAL VIEWS OF THE DRAWING

The present invention is better understood upon consideration of the following detailed description and the accompanying examples in conjugation with the drawings in which:

PIC 1. Is a simplified pictorial illustration of a network constructed in accordance with the preferred embodiment of the present invention, wherein all job related web servers and employers servers and HR companies servers and “Central site” server are connected to the Internet or to employers intranets or HR companies intranets together with other computers that are not part of jobs and candidates databases. Employers and HR companies Intranets have access to the Internet. Employers and HR companies job related servers can be accessed from the “Central site”.

PIC 2. Is a simplified pictorial illustration of the way candidate can apply to printed media job offers without exposing private information without need.
a. First method—Candidate access “Job offeror” directly:
   Step i. Candidate send resume to “Job offeror” with “Central site” contact information and “User unique code”.
   Step ii. “Job offeror” interested to return to the sending candidate, connect according to the contact information to the “Central site”.
   Step iii. “Central site”, according to candidate preferences and “Central site” policy, send candidate information to “Job offeror” for further recruitment procedure.
   Step iv. “Job offeror” connect directly to the candidate.
b. Second method—Candidate access “Job offeror” via “Central site”:
   Step i. Candidate sends a copy of the job offer to “Central site” together with “User unique code”.
   Step ii. “Central site” verify that job offer is already registered, and if not, register this job offer in the “Central site” and matches this job offer against registered candidates.
   Step iii. If user profile matched job offer, “Central site” send resume to “Job offeror” with “Central site” contact information and candidate “User unique code”.
   Step iv. “Job offeror” interested to return to the sending candidate, connect according to the contact information to the “Central site”.
   Step v. “Central site”, according to candidate preferences and “Central site” policy, send candidate information to “Job offeror” for further recruitment procedure.
   Step vi. “Job offeror” connect directly to the candidate.

### DETAILED DESCRIPTION OF THE INVENTION

The invention is a weighted system that takes into consideration most of the possibilities and factors to effectively assign best job seekers to job offers from candidates/companies and HR companies point of view.

This invention is based on a central web based system that generates “User unique code” for candidates which can be used when applying to job offers published over all medias, including printed media. This code accompanied with “Central site” contact information is used for “Job offeror” to contact the applying candidate.

“Central site” is a modular system based on issuing “User unique code” for candidates and value added adds-on services for candidates, companies and HR companies.

“Central site” matches candidates data to job offers registered in the system and apply with matched candidates for matching job offers.

Central site matching system enable job definition that include: register various parameters and keywords, indicating conditioned and ranked preferences for and between parameters and keywords reflecting suitable users for job offer; and enabling registered user to fill various parameters and keywords regarding job occupational profile.

Central site matching system allows also special job personality characteristics that meets the needs of the job offer selected category, enabling companies to indicate preferred characteristics for the job. User applying for the same job category is presented with characteristics suitable to the profile occupation category to select from.

These parameters and keywords are matches against each other while taking in consideration keyword and parameter ranking like must have, advantage, recommended for coarse screening and job offeror parametric ranking for best match user to company job offer.

In addition, “Central site” offers companies and HR companies tools to compare matching results from “Central site” and/or third party matching process for their job offers.

New registered candidate to the “Central site” is assigned a “User unique code”.

Candidates can register using the “Basic registration” or “Full registration” procedure. “Basic registration” allow candidates to apply to job offers published over all kinds of medias. “Full registration” also allows candidate profile to be matched against companies and HR companies job offers, some of these job offers are inserted to the system as candidate initiative in order for the system to apply for those job offers.

Companies and HR companies can register their candidate/allow their candidates to register to the “Central site” and be matched against job offers at their own web site or at “Central site”. These candidates when registered by companies and HR companies to the “Central site”, will be presented to the related company or HR company with full details as opposed to other non-related companies and HR companies that are presented discreet user information. When non-related company or HR company request to reveal candidate information, the request is transferred to the related company or HR company for approval. Request for details reveal for candidate registered to the “Central site” via multiple companies and/or HR companies and/or “Central site”, will be transfer to one of the companies according to candidate preferences and “Job offeror” selection.

Third party job web sites that are connected to the “Central site” will present “contingency buttons” to allow fast access to “User unique code” and/or “Basic registration” information and/or “Occupational profile” from the “Central site”. The information retrieved is applied directly to connected web site forms. Non connected web sites may present “partner button” that will direct candidate to register in the “Central site” and credit the web site with reward according to “Central site” policy.

Candidate may create and update multiple versions of its profile.

In order to keep Candidate status updated, “Central site” system offers incentives for candidates that keep their status updated. For example, stop charging candidate for special services or issue a user profile related coupon and the like.

Matched candidate with multiple registrations is presented in continuity order starting the best-matched entry. Different candidates are identified using color change and/or new candidate icon and/or the like.

Different people have different approach regarding user interface and other considerations to prefer certain web sites over other web sites. This is causing a normal distribution of candidates and “Job offerors” over multiple web sites. This invention allow “Job offerors” to compare matching results from various web site to get weighted results to reflect “Job offeror” preferences as follows:

“Job offerors” that publishes their offers over some web sites, are presented with candidate results from various web sites in a comparing table. “Job offeror” can then select its preferred web sites matching results. Comparing table presents candidates rows in web sites columns, where same candidates are presented with the same “Record number” retrieved from the “central site” and for comparison conveniences are presented with same color and/or other convenience indications. “Job offeror” may also define one of the compared results web sites as a reference guide for the comparison and matched candidates are presented in non-reference column with the “Record number” in the reference column for fast comparison.

This compare is based on per job offer matching results retrieved from connected job related web sites or HR companies. Matching results retrieval can be automatic or manual according to collaboration level with the connected job related web site or HR company. Automatic retrieval is done online and manual depends on Job offeror HR to retrieve candidates unique code results from the non-collaborating web site. This solution of comparing results by candidates unique codes, even if done manually, helps Job offeror to find and identify the best candidate to each job offer. Usually job related web site allow Job offeror to register the job number or code as it registered at its own system. In case job related web site does not allow it, Job offeror will manually select the web site referenced job offer number or code to compare results between some job related web sites.

“Job offeror” may also change matching result status in order to eliminate the need to revisit already visited candidates or eliminate candidates that does not comply with job request.

This invention also allows “Job offerors” to use candidates tracking tools to record candidate evaluation, transfer the candidate to company internal or external examination. This tool also can define candidate specific calendar, task list, contacts and the like. Related authorized people, may at all time track candidate progress in recruitment process. Company authorized people may also examine “Candidate status” and evaluation for other offers using “general status” report.

“Central site” allows candidates to apply for job offers published on all kinds of medias in a discreet way thus contributes to matching process that will result in best candidate for job offers over several web site. Thus, creating base for strategic collaboration between web site for the benefit of all parties in assigning candidates to job offers.

What is claimed is:

1. A method for distributing users resume to jobs published in printed and electronic media in a discreet way, the method comprising;
Providing a web site system, herein: “central site”, that generate identifying personal code for registered users to be used when distributing resume by the user and/or by central site matching system to published jobs and,
Providing matching compare services, keeping users privacy.
Providing an enrollment system which provide user when electronically apply to system with basic identification and contact details, with a personal identification code to be used together with central site contact details to replace user private and contact details when distributing resume to published jobs from all medias, and,
enable user to supply additional required details enabling matching user details to published jobs at mentioned medias by computer program matching system.
Providing registered companies with matching compare system allowing them to select their preferred matching systems to present results of matching users of a plurality of registered users, for selected company job offer as extracted from message request.
Receiving electronically a request message for user details that contains said user personal identifier,
Checking user confirmation to publish details to request company and/or request job as extracted from request message and if confirm,
Transmitting user details which corresponds to the user personal identifier as extracted from the request message to requesting company; and if not confirm, supplying suitable answer and not transmit user personal details to requesting company and,
Recording within computer memory the action.

2. The method of claim 1, wherein providing a user an enrollment system further comprising:
Providing basic user registration option enabling user to register using username/password, names, phones, electronic contact details like ICQ, Messenger, Skypee and may include additional contact and electronic contact details, herein “Basic registration”; and
Issuing a “user unique code” to be used as the user identifier throughout all job seeking activity from printed media and/or electronic media;
Providing user complete registration of user occupational profile as education and degrees, courses, languages, jobs experience and the like jobs related occupational profile details, herein “full registration”; and
Issuing a user resume that includes user unique code and occupational profile details and not include user basic details, herein “user discreet resume”;
Enabling full registered user print user discreet resume and save electronically copy within user computer; and
Combine full registered user in centralized web site matching system.

3. The method of claim 2 wherein Issuing resume for full registered user further comprising:
Issuing first resume version for full registered user;
Enabling user to create additional resume versions;
Enabling user determining title for each resume version;
Generating sequence number for each resume version;
Issuing electronic resume version including user unique code and occupational profile details and not including user basic details, herein “discreet resume”; and
Enabling user to print said electronic discreet resume versions and save electronically copy within user computer, indicating printed or uploaded date.

4. The method of claim 2 wherein issuing user unique code within central site enrolment system, further comprising issuing page of user unique code and central site contact details; herein “user identifying page” and enabling basic registered user and full registered user print “user identifying page” and save electronically copy within user computer.

5. The method of claim 1 wherein combining full registered user in centralized web site matching system further comprising:
a. Automatically enable all user resume versions for matching system or enabling per site approval according to site configuration.
b. distribute each matching user resume in a discreet way, with a “user unique code” replacing said user basic registration details.
c. enable user to indicate for each user resume versions to be match or removed from central site matching system.
d. enable user request to be removed from matching central web site services.
e. remove user from matching system upon user message of finding a job.
f. enable user to indicate for each user resume versions to be match or removed from matching compare system.
g. enable user request to be removed from matching compare system.

6. The method of claim 1, further comprising web sites partners with dedicated linked buttons to central web site, include: affiliate button and/or apply discrete button and/or apply convenient button and/or apply discreet convenient button and edit button.

7. The method of claim 6 wherein register user through affiliate button presented at partners web sites including:
a. registering within computer memory each allowed web site as partner for affiliate program sites.
b. supplying partner site with affiliate button computer code presents central site logo and dedicated text to be presented at partner site in exchange of agreed commission.
c. transmitting to the user's computer a central registration web page as extracted from request message generated by a computer of a user in response to selection by the user a said affiliate button.
d. recording within a computer memory transmitting actions and registration actions of users using the partner identifier as extracted from the request message to identify the partner site; and
e. determining and recording within a computer memory compensation to the partner site as defined at agreement between central site and partner site.

8. The method of claim 6 of user register to other job related partner web sites, herein “partner site”, through apply with discreet button comprising:
Register within computer memory allowed web sites as partners for user apply with discrete button linked to central web site;
Supplying partner site with apply discreet button presents central site logo and apply discreet text to put at its registration page;
Transmitting to user's computer a central web site login web page which corresponds to the button function identifier extracted from request message generated by a computer of a user in response to selection by the user a said apply discreet button, allowing user to login as registered user or register to central web site to get user unique code;
In response to supplied details of user name and password as extracted from request message generated when submitting login part for registered users at said central login web site page, presented by submitting apply discreet button at said partner site and validate details within computer memory, getting user electronic approvement for transmitting its user unique code to said partner site, transmitting response message to partner site with user unique code corresponds to user name and password details as extracted from said request verified message;
In response to request message for registration action at central web site as received from register link for unregistered users part at said central login web page, presented by submitting apply discreet button at said partner site, enable user to register upon his preference with basic registration or full registration option, getting user electronic approvement for transmitting its user unique code to said partner site, transmitting response message with user unique code as issued for registered user at central web site; and
Presenting at register form at said partner site a user unique code as extracted from said response message, and
Getting a submit request of register form at said partner site will record user unique code within partner site system in addition to other details as filled at partner site register form and determined by partner site to be recorded.

9. The method of claim 6 wherein user register to other job related partner web site, herein “partner site”, using convenient button comprising:
Register within computer memory allowed web sites as partners for user apply with convenient button linked to central web site;
Supplying partner site with “apply convenient button” presents central site logo and apply convenient text to put at its registration page;
Transmitting to the user's computer a central web site login web page which corresponds to the button function identifier extracted from request message generated (by a computer of a user) in response to selection by the user a said apply convenient button;
Receiving from user details of user name and password as extracted from request message generated by a computer of a user in response to submission by the user a said central web site login web page presented by submitting apply convenient button at said partner site;
Validate details within central site computer memory;
Getting user electronic approvement for transmitting its user occupational details of selected user resume version that may be part of some user resume versions to said partner site;
Transmitting response message with user occupation details corresponds to user name and password details as extracted from request message generated when submitting central site login page with user name and password details, the login page generated in response to selection by user of convenient button at user occupation web page of said partner web site;
Extracting at partner site by computing software user occupation details from response message, based on central site API, and put details in fields with accordance to relevant said partner web site fields.

10. The method of claim 6 wherein user register to other job related partner web site, herein “partner sites”, using discreet convenient button comprising:
Register within computer memory allowed web sites as partners for user apply with discreet convenient button linked to central web site;
Supplying partner site with apply discreet convenient button presents central site logo and apply discreet convenient text to install at its registration page;
Transmitting to the user's computer a central web site login web page which corresponds to the button function identifier extracted from request message generated (by a computer of a user) in response to selection by the user a said apply discreet convenient button, allowing user to login as registered user or register to central web site to issue user unique code and occupational details;
In response to supplied details of user name and password as extracted from request message generated when submitting login part for registered users at central site login page presented by submitting apply discreet convenient button at said partner site, and validated within computer memory, getting user electronic approvement for transmitting its user unique code and occupational details based on selected user resume version that may be based on some user resume versions to said partner site; and transmitting response message to said partner site with user unique code and occupation details corresponds to user name and password details as extracted from said request verified message;
In response to request message for registration action at central web site page as received from register link for unregistered users part at said central login web page, presented by submitting apply discreet convenient button at said partner site, enable user to register to central site upon his preference with basic registration or full registration option; getting user electronic approvement for transmitting its user unique code and occupational details of selected user resume version that may be part of some user resume versions if user registered as full registration option, to said partner site; transmitting response message to said partner site with user unique code as issued for registered user at central web site, and transmitting occupation details for full registered user;
Extracting at partner site by computing software user unique code and extracting occupation details, based on central site API, if provided from response message, and put details in fields with accordance to relevant said partner web site fields;
Getting a submit request for filled register form at said partner web site will record user unique code and user occupation details as filled to partner web site system and, may record additional details as filled at partner site and determined by partner web site to be recorded.

11. The method of claims 6 wherein enabling user using dedicated buttons of affiliate and/or apply discreet and/or apply convenient and/or apply discreet convenient buttons linked to central site, further comprising enabling user edit registered details at central site.

12. A method of applying in a discreet way for jobs at web sites demanding user to register in order to distribute resume or applying to jobs by signing interested jobs wherein ignoring advertised company contact details, the method comprising:
Register special user unique code based on letters, as provided from central site, at fields of private and family name at register form of said web site; herein “special letters unique code”;
Register phone and email details of central site contact details; or if needed unique email by said web site or by user preference,
Register user phone and email details; and, if provided by registered site option to upload resume by user: uploading preferred discreet resume version as issued at central site, including contact details of central site and user unique code, and not include user basic details;
Receiving requests to contact user through user supplied phone or email, enabling user to determined whether to supply its private details or not, or, providing central site contact details as allowed company to expose user contact details based on user confirmation;
Receiving request to contact user by central web site, through contact details appeared at user supplied central site issued resume, uploaded by user to said web site,
Contacting user as identified by supplied user unique code or user special Letters unique code in electronically way for private details approve to requested message, supplying all details supplied by requested company describing suggested job and/or company;
Providing user with company contact details and/or;
Providing requested company with user contact details; and
Recording action within web site system.

13. The method of claim 12 wherein provided by registered site option to upload resume by user further comprising uploading preferred discreet resume version that not issued by central site, and attach electronic document issued by central site for basic registered users, includes contact details of central site and registered user unique code, and not include user basic details;

14. The method of claim 1 wherein allowing users distribute resume in discreet way to jobs published at all medias, supplying user details by company request and user confirmation further comprising companies registration including:
a. register usual company details of company name, address, contact details;
b. assign indicator for recruitment company;
c. assign indicator wherein the company is partner site;
d. assign indicator wherein the company register to central site services.

15. The method of claim 1 of allowing users distribute resume discreet way to published jobs at all medias further comprising:
Uploading to central site system jobs published at all medias by central site dedicated team, based on rules for said action at relevant area or country;
Getting jobs published from all medias by users;
Registering approved jobs to central site system; and
Enable users distribute discreet resume independently and/or by central site matching system.

16. The method of claim 15 further comprising uploading to central site and registering jobs by companies registered to central site services.

17. The method of claim 15 wherein getting job published at any media by user comprising:
Getting from user job details and/or job copy of paper media or job Electronic media address by electronically way as fax, dedicated email address, dedicated web site address and/or other electronic options determined by central site team;
Verifying by central site team existence of dedicated job at web site system with same details by: job published code and/or job title and/or company name and/or additional details;
Registering unregistered job with details of: source job as newspaper name and/or web-site address etc., published date, job company if provided, job published code if provided, job title if provided, job description if provided, must requirements if provided, advantage requirements if provided, administration details as last date for applying job etc. if provided, persons contact details if provided and mail or electronic address details to send resume.
Issuing internal site code for the job and,
Recording the job within system site computer memory.

18. The method of claim 15 wherein approving jobs published at all medias to be registered at central site system comprising:
Verifying existence of each published dedicated job at web site system with same details by job published code and/or job title and/or company name and/or additional details.
Registering unregistered job with details of: source job as newspaper name and/or web-site address etc., published date, job company if provided, job published code if provided, job title if provided, job description if provided, must requirements if provided, advantage requirements if provided, administration details as last date for applying job etc. if provided, persons contact details if provided and mail or electronic address details to send resume.
Issuing internal site code for the job and,
Recording the job within system site computer memory.

19. The method of claim 1, wherein distributing discreet resume by the user to jobs published in printed and electronic media and wherein the jobs presented or advertised at central site, the method comprising:
Getting user request to send discreet electronic resume to jobs advertised at central site identified page;
Identifying registered user by regular known login details as user name and password;
Presenting to identified logged in user his resume versions include its titles;
Getting resume version selection from user; and
Sending discreet resume version as selected by user;
In case of basic registered user:
Presenting to identified logged in user his user unique code together with central site contact details, enabling user to attach resume, indicating him to upload resume that not include basic details;
Getting request message by contact web site details as supplied at electronic discreet resume, or, in case of basic register user, contact details supplied within electronic page supplied by central site and include user unique code and central site contact details, from registered or unregistered company that include: job code at published media and/or job code at central site and/or job title and/or company name, and requested user unique code;
Record request message within computer memory;
Getting user confirmation by electronic way of email or SMS or phone or other registered electronic contact option for dedicated user with accordance to central site policy for publishing private contact user to requested company;
Record user confirmation within computer memory and provide requested company with user private contact details; or in case that user not confirm publishing private contact user details,
Record user rejected answer within computer memory and not provide requested company with user private contact details, and provide suitable answer to requested company.

20. The method of claim 19, wherein user distribute independently discreet resume to jobs advertised at central site further comprising uploading user private issued discreet resume or user issued by central site discreet resume as printed or saved electronic way by computer of registered user.

21. The method of claim 1 wherein users distribute resume in discreet way to jobs published at printed and electronic media presented at central site within central site matching system, the method comprising:
Approving by central site system each user resume version to be processed at matching system;
Getting from user confirmation to automated sending discreet electronic resume to matching jobs contact addressees upon central site matching system;
Getting from registered companies to matching central site services indications for requesting user or users contact details;
Getting from unregistered companies to matching central site services, message request for user or users contact details, using user unique code and central site contact details as supplied on distributed discreet resumes;
Getting user confirmation by electronic way of email or SMS or phone or other registered electronic contact option of the specific user with accordance to central site policy, for publishing user private contact details to requested company, supplying user with company approved details of company name, job title, job description and other relevant supplied details;
Record user confirmation within computer memory and present to the requesting company user basic details electronically; or in case that user not confirm publishing private contact user details,
Record user rejected answer within computer memory and not provide requested company with user private contact details, and provide suitable electronic answer to requested company.

22. A method of users distribute resume in discreet way to jobs published at printed and electronic media, wherein providing central site system that includes jobs that registered by company's representative herein “company rep.”, enabling them to use matching central site services, further comprising evaluating and tracking user system, while keeping user privacy including:
Getting from company rep. confirmed business agreement specifies legal terms for using evaluating and tracking user system; and getting from company rep. confirmed business agreement specifies legal terms for using said evaluating and tracking user with accordance to matching system of central site;
Enabling company rep. to define privileged users to use said evaluating and tracking user system, and enabling registering said users by mean of company, title, email address and may include additional required details, providing to each said register user, herein “evaluate user”, login details to said evaluating and tracking system;
Enabling company rep. to add comments and/or attached file to discreet resume of dedicated match user regarding dedicated match job within evaluating and tracking user system, and forwarding comments and attach file and said discreet resume to selected evaluate users by its registered email or by internal connected mail, using user name and name of evaluated user to define forwarded user;
Enabling each evaluate user to receive discreet resume of dedicated match user regarding dedicated match job from company rep. include comments and attached file added by company rep. within evaluating and tracking user system; and
Enabling each evaluate user to forward it to each other evaluate user and/or response to company rep;
Each evaluate user and company rep. can enter anytime to internal mailing box, track concentrated comments and attached files for said discreet resume, indicating evaluate user name or company rep. and date of commenting;
Each evaluate user and company rep. can add comments, forward comments and response to existing comments of said discreet resume within evaluating and tracking web site system anytime;
Enabling company rep. to change match user status within matching system or within evaluating and tracking system to “enable user details” request;
Getting by central site user confirmation that recorded within computer memory as described at claim 21 will expose said match user basic details to said company to said match job, changing match user status to “exposed user” for dedicated company for dedicated job.

23. The method of evaluating and tracking discreet users of claim 22 further comprising evaluating and tracking user after exposing his basic private details, including:
Applying said forwarding method of discreet user within evaluating and tracking system to user exposed details, indicating user status at hiring process steps;
Enabling company rep. to change user status within evaluating and tracking system with accordance to hiring process steps like: interview, examine, contract, hiring, rejection and other available hiring steps, and enable company rep. to add comments regarding each step.

24. The method of claim 1 further comprising enabling job services for registered company including: (a) register company jobs to central site system (b) register private users applying for jobs at said company or through said company; herein “company users” (c) getting matching users for company registered jobs (d) getting matching jobs for company users (e) using evaluating and tracking user system (f) using matching compare system.

25. The method of claim 24 wherein registering private users applying for jobs at regular company or applying for jobs through recruitment company comprising:
Register company at central site;
Indicating requested amount of needed private users registration;
Issuing by central site system needed amount codes for company users;
Providing company the issued codes electronically by mail or by providing discreet web page present company users codes to login identified company rep.
Providing to each company user a code number to supply at registration at central site;
Presenting to company rep. matching users that indicated at central site system as company users with exposed basic private details and;
Presenting to company rep. matching users that not indicated as company users in discreet way, ignoring users private basic details and;
Presenting company users to other registered companies using central site matching services, said company users in discreet way, ignoring users private basic details;

26. The method of claim 25 further comprising enabling user register to central site through multiple recruitment companies and/or companies. by supplying company code and register to central site system or supplying company code and supplying user name and password of already registered user.

27. The method of claim 26 wherein distributing resume to jobs published at all medias in discreet way, wherein providing user private basic details to requested company by user confirmation, and wherein user register as company user of multiple recruitment companies and/or companies further comprising, transferring company request to company user as identified with accordance to requested user record within computer memory.

28. The method of claim 1 wherein enabling full registered users automatic distributing discreet resume through matching system of central site, the method comprising:
Providing computing system enabling electronically registering jobs within central site matching system web page including: registering variant parameters and keywords, indicating conditioned and ranked preferences for and between parameters and keywords reflecting suitable users for job offer, as registered by company rep. or as defined for published job at advertised media source and registered by central site team;
Providing computing system enabling electronically registered user to fill variant parameters regarding job occupational profile within central site system;
Providing matching system that operates computer programming configured to find suitable users for suitable jobs with accordance to registered jobs and registered users provided details and conditions;
Presenting automatic matching discreet resumes to log in registered company rep. for each company registered job, enable him upon business agreement to use evaluating and tracking user system, and enable him to request user private basic details and;
Sending automatic discreet resumes to matched jobs electronic addresses as registered by company rep. in frequency as determined by central site admin;
Sending automatic discreet resumes to matched media advertised jobs electronic addresses as registered to central site and approved by central site rep. in frequency as determined by central site admin;
Presenting automatic matching jobs to full registered user, enable him sign interested jobs and enable him to add user page to each matched job to be presented to company rep within user electronic discreet resume; and
Sending automatic matching jobs allowed details to full registered user electronic address.

29. The method of central site matching system of claim 28 further comprising enabling defines “and/or” options between education category learning for same degree and for different degree, and between specified keywords for registering job.

30. The method of central site matching system of claim 28 further comprising enabling indication for must or preferred option for registered job parameters of: level education degree, field of education, level degree, field of education within specified institution, level for specified language for speak, read, hear, course name, course name within specified institution, keywords and number years for each keyword or each set of keywords, personality description.

31. The method of central site matching system of claim 28 further comprising enabling registered company rep. to indicate preferred rating for all registered job preferred parameters, wherein presenting user selectable box of numbers adjusted to total job parameters numbers, enabling company rep. to select preferred graded rating from selectable box presenting next each parameter, determining using each grading number one time or using grading number several times for different preferred parameters, indicating same weigh rate for said preferred parameters;

32. The method of central site matching system of claim 28 further comprising supplying list of personality characters with accordance to selected category at job register form, to indicate the preferred characters to registered job.

33. The method of central site matching system of claim 28 further comprising supplying to full registered user list of personality characters with accordance to selected category, enabling user to select the suitable character.

34. The method of company register a job at central site system of claim 24 further comprising enabling company rep. to identify default choice to be presented automatically at job register form as identified for identified company rep. enable company rep. to submit job with default choice or change default choice and submit job, recording job with changed parameters as determined by company rep. at said job register form.

35. The method of central site matching system of claim 28 further comprising enabling user define for each experienced job position some sets of keywords and number years for each set, and presenting to company rep. total number of years for each keyword based on total experience within all user experience jobs positions.

36. The method of claim 28 of central site matching system further comprising supplying company rep. instructions to fill keywords with accordance to selected category at job register form.

37. (canceled)

38. The method of claim 28 of central site matching system further comprising directing user to suitable keywords to fill with accordance to selected job category.

39. The method of claim 28 of central site matching user further comprising presenting to company rep. resumes of matching users indicating the last user updated date.

40. The method of claim 28 of central site matching system further comprising enabling company rep. define status for discreet resume such as: read, don't show, interesting and like.

41. The method of claim 28 of sorting and ranking users by computer software of central site matching system for each open job position comprising:
Presenting matching users with must fields only as defined at registered job;
Providing high rank to matching users with advantage parameters as defined at registered job;
Sorting match users with advantage parameters with accordance to preferred ranked parameters as defined at registered job.

42. The method of claim 1 wherein automatic distributing discreet user resume through central site matching system to all published jobs as registered to central site matching system, further comprising presenting matching services to identified user logged in site system including:
Presenting matching jobs registered by company's rep. indicating company name;
Presenting discreet matching jobs registered by company's rep. without presenting company name;
Not presenting discreet matching jobs registered by company's rep. indicating not show job to users;
Presenting approved matching jobs uploaded by users and/or central site team from variant media sources, indicating details as provided at published jobs;
Enabling user to attach page to existing electronic resume, indicating to match company job promoted and explanation details of said match user.

43. The method of claim 1 wherein distributing automatically discreet resumes to published jobs within matching system in central site further comprising helping issuing intelligent learning software including: define connected parameters, request statistic info for defined parameters as registered within computer memory, present usual connected parameters based on defined amount of founded connections for defined connected parameters at job registering form and at user profile registering form with accordance to predefined form registered parameters.

44. The method of claim 1 wherein facilitating compare matching system, presenting user in discreet way comprising:
Register companies that supply matching services within matching compare system at central site, herein “matching service company”;
Register companies that approved to use matching compare services;
Transfer interface definitions (API—application programming interface) to the companies that supplying matching services within central site matching compare services to define:
a. Request fields codes, structure and protocol to send request message for matching candidate for identified job of identified company;
b. Response fields codes, structure and protocol to send response message of matching candidates for identified job of identified company;
c. Error codes for application level and for communication level;
d. Define security tools to send and get messages between computing system that supplying matching services and central site computing system.

45. The method of supplying matching results within central site matching compare services of claim 44 comprising:
Registering company to central site system;
Approving company as matching services company;
Electronically forwarding business agreement and interface API and getting back signing business agreement for terms of use of matching compare services including using partner buttons, at least discreet button or discreet convenient button; including acting with accordance to said interface definition (API);
Providing matching service company partner buttons allowing user register discreetly, including installation instructions, to install at matching service company registration form;
Record within central site computer memory approved matching service company.

46. The method of presenting matching users at matching compare services of claim 44 comprising:
Getting company and related job identifiers and preferred matching service companies identifiers at central site system;
Forwarding matching request to each matching services company with accordance to matching companies identifiers;
Getting back from each requested matching company services, message response includes:
matching user codes as supplied to registered user and registered within central site registration system and/or registered within discreet button or discreet convenient buttons presented at register web page of matching system partner web site; and includes details of: matching system ranking for each match user identified code, resume page within said matching system, job identifier, identified job title, company identifier, identified company name;
Extracting by central site software system responded details; and
Presenting at central site matching compare system web page results in comparable view including: (a) presenting columns of preferred allowed matching systems indicating matching company name and title job as extracted from response message; in each column presenting rows of short record number, issued by central site within computer memory for each registered user to be combined at matching compare services, with accordance to user code identifier as extracted from response message of said matching company; (b). clicking on user identifier will present user resume as extracted from response message of said matching company; (c). clicking on user presented code or moving cursor on user code at each column matching results of said matching systems, will present up and down signs at same preferred user row next each presented matching system; each sign when clicked, present page part of ranked preferred user at matching system of clicked sign; click on user code present user resume of matching system of clicked sign; and presenting up and down signs for preferred user code as ranked at other presented matching system.

47. The method of matching compare services of claim 44 wherein companies registered as central site partners enabling user register within their site in discreet way, using supplied buttons from central site, further comprising providing partner companies dedicated button connected to central site system that when clicked, cause system to send edited employment status of users registered discretely thru partner site, indicating for each user: user unique code, employment status, indicating last date of updated details by user, indicating last date of updating user employment status within computer memory of central site.

48. The method of claim 47 further comprising:
Enabling company rep. presented by user matching system resume wherein clicked at user code at preferred matching system, to send request message within dedicated button presented on said resume page; the request message recorded at central site computer memory indicating requested company identifier, presented matching system identifier, match job identifier, user code identifier and requested date;
Central site will notify electronically the preferred matching company, wherein user was clicked for details; and get user confirmation for providing basic details to requested company upon agreement with said matching company and user predefined preference as indicate at central site registration system.

49. The method of claim 47 wherein presenting ranking user resume, further comprising presenting the user resume according to the best ranked user resume version.

50. The method of claim 1 wherein central site matching system and matching compare services further comprising using frog, shoes, prince and princess signs.

51. The method of claim 1 wherein allowing user distribute discreet resume to one of the plurality of companies and/or one of the plurality jobs published at one of the plurality of medias sources by the user or by matching central system, and supplying matching compare services, is via a communication network.

52. The method of claim 51 wherein the communications network is Internet.

53. A method for distributing users resume to jobs published in printed and electronic media in a discreet way, the method comprising:
providing Dynamic job services central web site based on scripting language like ASP, PHP or other languages; and
Providing distributed Database to hold and manipulate all jobs, users, companies, hr companies and job related web sites partners related data; and
enabling at least one of the plurality of users to distribute at least one of the plurality of resume in a discreet way to one of the plurality of jobs published within at least one of the plurality of printed and electronic medias, and
enabling central site system to exchange jobs and users information with at least one of the plurality of companies and/or hr companies and/or job related web sites via internet and/or intranet network.
